(19) United States
(12) Patent Application Publication
(10) Pub. No.: US 2014/0304096 A1
(43) Pub. Date: Oct. 9, 2014

(54) Business Process Management System

(71) Applicant: Udaya Devineni, Norcross, GA (US)

(72) Inventor: Udaya Devineni, Norcross, GA (US)

(21) Appl. No.: 14/218,964

(22) Filed: Mar. 18, 2014

Related U.S. Application Data
(60) Provisional application No. 61/802,261, filed on Mar. 15, 2013.

(51) Int. Cl. G06Q 20/20; G06Q 10/08

(52) U.S. Cl. CPC G06Q 20/203; G06Q 10/087
USPC 705/22

(57) ABSTRACT

Systems and methods for providing improved efficiency and management of business processes are provided. The management of business enterprises such as convenience stores is improved by tracking and verifying shift data as relates to tracking fuel availability, settling and tracking inventory, and auditing lottery information.

### CROSS-REFERENCE TO RELATED APPLICATIONS

This application claims the benefit of U.S. Provisional Application No. 61/802,261, entitled “Business Process Management System,” filed Mar. 15, 2013, which is incorporated herein by reference as if set forth herein in its entirety.

### BACKGROUND

This invention pertains to the functionality and viability issues convenience store owners and operators face with regards to their lottery, fuel and inside sales operations. More particularly, this invention pertains to the difficulties presented by the current excess of manual paperwork in the industry and the resulting errors, pricing discrepancies created by a frequently changing market and poor sales data to satisfy customer demands, thus hindering sales.

### BRIEF SUMMARY

Systems and methods for providing improved efficiency and management of business processes are provided. In particular, the management of business enterprises such as convenience stores is improved by tracking and verifying shift data as relates to tracking fuel availability, settling and tracking inventory, and auditing lottery information. Each of these capabilities also finds use in various other type markets.

According to one embodiment of the present invention, software and hardware components are utilized throughout the business process, in the form of client computing devices allowing operators organized access to vendor and market data, terminals that track point-of-sale systems at one or multiple convenience store locations, and software that utilizes all available data into regular reports for convenient access to business information via secure internet connection regardless of time or the operator's location.

Another embodiment provides for cloud computing solutions which integrate real-time market pricing data allowing operators to make adjustments that best suit customer needs, thereby improving sales margins. Conversely, customer preferences and purchases over any given period of time can be examined by the operator via information gathered from individual stores' point-of-sale (POS) systems, preventing inventory shortages and surpluses.

Tracking and verification of employee shift data, fuel deliveries and shipments, auditing of lottery sales and inventory, and in-store sales records are monitored and organized for the operator.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is a system diagram showing aspects of one system presented herein for providing and managing a business process management system, including several software and hardware components utilized in various embodiments disclosed herein;

FIG. 2 is a flow diagram showing a routine that illustrates aspects of the operation of the business management service in one embodiment presented herein for closing a shift;

FIG. 3 is a flow diagram showing a routine that illustrates aspects of the operation of the business management service in one embodiment presented herein to audit the lottery transactions during a shift;

FIG. 4 is a diagram illustrating functionality for processing fuel records and information;

FIG. 5-A is a diagram illustrating functionality for processing inside sales records and information for a store;

FIG. 5-B is a flowchart showing the way DFMS facilitates interaction various components of an embodiment of the system;

FIG. 6 is a flow diagram showing a routine

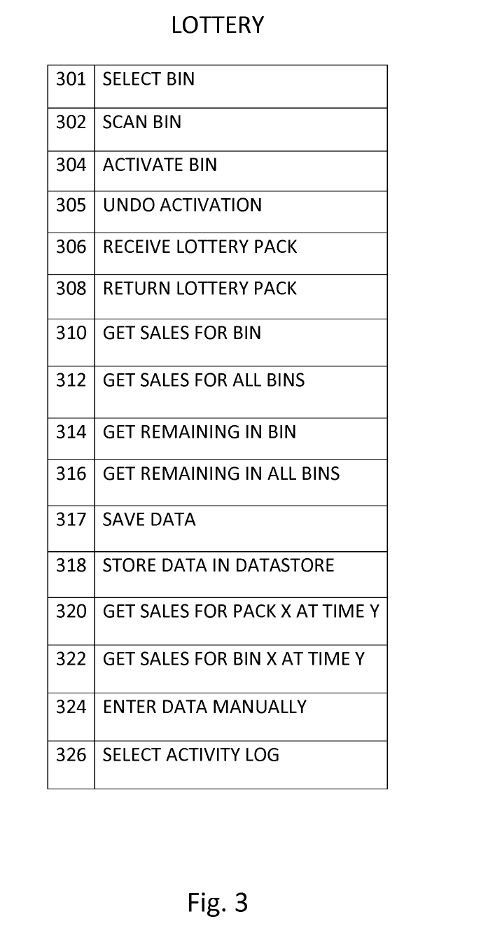

FIG. 3 is a flow diagram showing a routine

### DETAILED DESCRIPTION

The following detailed description is directed to technologies for providing improved efficiency and management of processes used by business enterprises. Through an implementation of the technologies disclosed herein, a business process management service is provided for tracking and verifying shift data as relates to tracking fuel availability, settling and tracking inventory, and auditing lottery information. Each of these capabilities finds use in the management of convenience stores and the like, while also proving useful in various other type markets.

Software and hardware components are utilized throughout the business process, in the form of client computing devices allowing operators organized access to vendor and market data, terminals that track point-of-sale systems at one or multiple convenience store locations, and software that utilizes all available data into regular reports for convenient access to business information via secure internet connection regardless of time or the operator's location.

Cloud computing solutions integrate real-time market pricing data allowing operators to make adjustments that best suit customer needs, thereby improving sales margins. Conversely, customer preferences and purchases over any given period of time can be examined by the operator via information gathered from individual stores' point-of-sale (POS) systems, preventing inventory shortages and surpluses.

Tracking and verification of employee shift data, fuel deliveries and shipments, auditing of lottery sales and inventory, and in-store sales records are monitored and organized for the operator. It should be appreciated that the subject matter presented herein may be implemented as a computer process, an electronic computer-controlled apparatus, a computing system, or an article of manufacture, such as a computer-readable storage medium. These and various other features will become apparent from a reading of the following disclosure and a review of the associated drawings.

While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced on or in conjunction with other computer system configurations beyond those described below, including multiprocessor systems, microprocessor-based or programmable consumer electronics, minicomputers, mainframe computers, handheld computers, personal digital assistants, cellular telephone devices, electronic-book readers, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures.

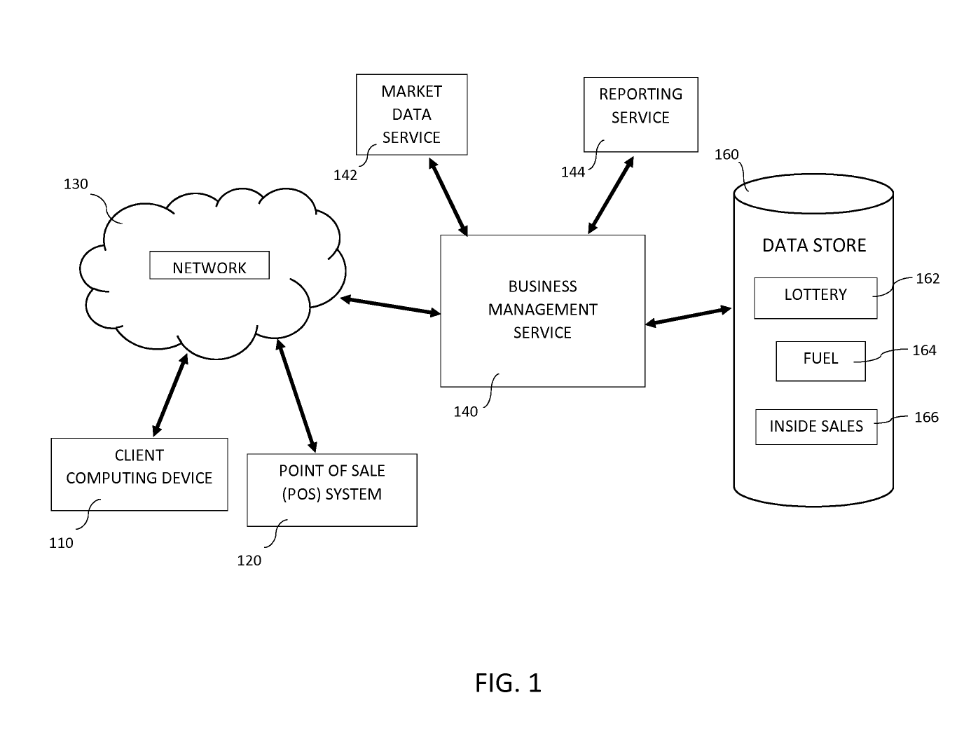

FIG. 1 is a system diagram showing aspects of one system presented herein for providing and managing a business process management system, including several software and hardware components utilized in various embodiments disclosed herein. The illustrative system 100 shown in FIG. 1 includes a client computing device 110, terminals for point-of-sale (POS) 120, and the business management service 140. Any number of additional client computing devices 110 and POS 120 terminals may be present. The business management service 140 is utilized by one or more client computing devices 110 for tracking and verification of shift data related to tracking fuel deliveries and shipments, settling and tracking inventory, and auditing lottery sales and inventory. A data store 160 is accessible to the business management service 140 and is utilized for the lottery records 162, fuel records 164, and sales records 166. The configuration and operation of each of these components is described in detail below.

The client computing device may be a personal computer (“PC”), desktop workstation, laptop computer, tablet computer, notebook computer, personal digital assistant (“PDA”), electronic-book reader, game console, set-top box, smart phone, consumer electronics device, server computer, or any other type of computing device capable of connecting to the network 130 and communicating with the business management service 140. Additional client computing devices 110 may be active within the system 100 to utilize the business management service 140.

The network 130 may be a local-area network (“LAN”), a wide-area network (“WAN”), the Internet or any other networking topology known in the art that connects the client computing device 120A to the business management service 140.

A market data service 142 provides capability for the business management service 140 to retrieve current or real-time market data for use in managing the business processes.

A reporting service 144 provides for the generation of reports based on the results of the business management service 140 in interaction with the various business processes.

In the illustrated embodiment, the client computing device 110 is typically a store machine available to the workers in charge of managing the current shift, and provides access to the business management service 140. The business management service 140 is hosted on a server (not shown) that is made available to the client computing device via a network 130.

The POS 120 provides payment information that is retrieved by the client computing device 110 during each shift closing operation. Additional information that is provided includes the payment types utilized, departments, and tax rates. The information is retrieved by the client computing device 110 during setup, at the beginning of a shift, and again at shift closing. The market data service 142 is utilized via the business management service 140 to access market data including lottery information and local fuel prices. These are made available to the client computing device 110 via a data store 160 that also includes rack prices and grocery inventory.

In one embodiment, rack prices are retrieved to the client computing device 110 every two hours. Lottery prices are retrieved every 24 hours, and fuel prices are retrieved every 2 hours. The client computing device 110 has a configuration that is synchronized with the business management service 140 every 24 hours.

In one embodiment, a customer email pulls a weekly lottery report every 7 hours. Shift and daily report emails are configured according to store specifications.

The client computing device 110 has access to the business management service 140, and thus to the store records including the lottery records 162, fuel records 164, and inside sales records 166 for any desirable period, including any available online market data.

In various embodiments, different computing devices are utilized in the system 100. In one embodiment, the client computing device 110 is an off-the-shelf PC that utilizes the business management service 140. It should be noted that the business management service 140 can be provided on a server having an Ubantu version of Unix, OPEN JDK, and an H2 file database.

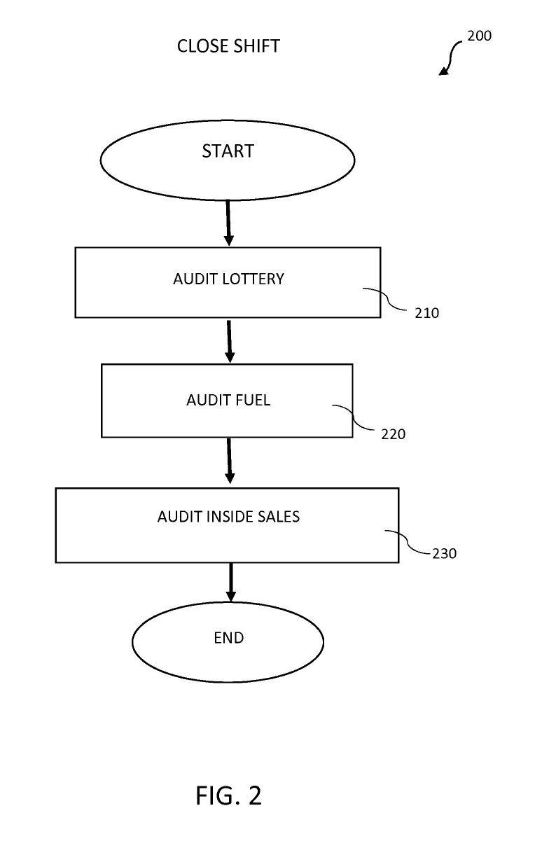

FIG. 2 illustrates various servers utilized in the business management system. In one embodiment, the store machine includes an off-the-the shelf PC with a dual-core processor utilizing the client application of the business management system, the Ubantu version of Unix, OPEN JDK, the H2 file database. Those of skill in the art will readily appreciate that other configurations will provide a suitable environment for accessing and utilizing the business management service 140.

In another embodiment, the system 100 architecture includes a webserver, OPEN JDK, TomCat, MySQL, a virtual server, and Ubantu Unix.

In one embodiment, the market data service 142 is provided via a (1) Market Data Application, .NET, and a JAVA application, (2) MSFT IIS, TomCat, OpenJDK, and (3) MySQL Environment DB, MY SQL Virtual Server on Ubantu, TomCat/OpenJDK environment virtual server on Ubantu, and MSFT IIS Environment virtual server on a Windows Server 2008.

In other embodiments, a first server provides admin test and market data. A second server provides remote support. A third server provides setup capability. A fourth server is used for system administration and to provide market data.

FIG. 2 is a flow diagram showing a routine 200 that illustrates aspects of the operation of the business management service 140 in one embodiment presented herein for closing a shift. In one example, a clerk utilizes the client computing device 110 to access the business management service 140 for closing the shift.

The routine 200 begins at operation 210 where the business management service 140 performs an audit of the lottery transactions. Once the audit of the lottery transactions have completed, the routine 200 then proceeds to operation 220 where the business management service 140 performs an audit of the fuel transactions. Once the audit of the fuel transactions have completed, the routine 200 proceeds to operation 230 where the business management service 140 performs an audit of the inside sales transactions. Once the audit of the inside sales transactions have completed, the routine 200 proceeds to operation 299, where it ends.

Utilizing the business management service 140 in this manner provides instant access to sales record for a desirable period of time such as per day, per week, per month, or event during certain hours of a day or week Likewise, inventory totals are available at any time and/or for any time period for determining increase, decrease, reorder requirements, or other sales patterns according to the desires of the user. Similarly, the business management service 140 provides instant access to matters that have been settled as well as matters that are outstanding. Also, the business management service 140 provides capability for better planning in terms of upcoming payments due to employees, vendors, jobbers, and the like.

FIG. 3 is a diagram 300 illustrating functionality for processing lottery records and information. The business management service 140 provides routines to scan a bin into the records 302, activate a bin for sales 304, receive delivery of a lottery pack into inventory 306, return a lottery pack 308, retrieve the current sales total for a bin 310, retrieve the current sales total for all bins 312, determine the remaining items within a bin 314, and determine the remaining items within all bins 316. A routine for storing data 318 provides capability for permanently storing any or all data into the lottery records 162 in the data store 160. A routine to get sales for bin X through time Y 320, provides for the capability of determining sales during a range or period of time. In this way, the business management service 140 provides capability for retrieving the above information at a given time past or present via accessing the lottery records 162 in the data store 160. It should be noted that other routines may be provided and that additional routines may be created via utilizing these exemplary routines.

Utilizing a portion of the provided routines provides the capability for determining a snapshot of sales at present, at some point past, within a particular bin or group of bins, or during a window of time. For example, a user could ascertain whether certain bins are less likely to sell, or whether certain packs are likely to sell in any bin location while others do not. Such capability allows a user or store manager to maximize profits according to particular results gathered from the lottery records.

Additionally, the above routines provide the capability for tracking bin sales according to age. For example, an owner may determine that certain bins and/or packs have been aging for too long a window of time. This provides an indication that these particular items are not selling.

Lottery is an important part of the business for those who have it. The business management service 140 provides for tracking the complete lottery life cycle from delivery to settlement. The information is in the business management service 140. Fuel orders and deliveries are another portion of a store clerk's duties and includes orders and deliveries. Finally, there are expenses, paying workers, vendors and such like.

In an example of a lottery delivery, the business management service 140 displays text for selecting lottery and delivery inventory from lottery activities at the home screen utilizing a portion of the routines described above. In one embodiment, a selectable white box provides for scanning barcodes of the game packs and providing a listing of the scanned pack images.

The lottery management functionality captures the information and provides for detailed and specific analysis as to how much was sold in a day, a week, or a month. Heretofore there has not been a method to delimit the beginning or end of the lifecycle through available records.

Lottery activation is performed by selecting the lottery activation button, selecting a bin, selecting the scan bin 302 option to scan a lottery pack and then selecting the save option. If the scanner is not working, a manual entry button provides for entering the game number and pack ID followed by selecting the save option.

Lottery pack activation can be removed by selecting the activity log option and selecting the bin to be undone. The image of the current game and current pack number, last game and last pack number appears on the right of the display. Selecting the undo button will then undo the lottery pack activation.

Lottery full pack sales are provided by selecting the full pack sales button and selecting the scan option. Scanning the lottery pack is followed by selecting the save option. If the scanner is not working selecting the manual entry button provides for entering the game number and pack ID number. Selecting save completes the process.

Bad lottery packs return can be returned and functionality for the return is provided. Bad lottery packs are returned via selecting the lottery returns option and selecting the scan option to the left. After scanning the lottery pack, the save option completes the process.

Discontinuing games is used when the lottery authority discontinues the game. Discontinuing a game is performed by selecting the lottery returns option and then selecting the game option. The game number to be discontinued is entered and confirmed. The return pack option is then selected and the prompt “Bins to be Scanned” is displayed with a Yes or No choice. After selecting the Yes and then the scan option, the lottery pack located in the highlighted bin to the right is scanned. Selecting the save option completes the process.

The business management service 140 provides reports for eliminating the discontinued games automatically from the inventory. Throughout the business management service 140, the delivery, status, and activation together provide a status aspect for reporting what is happening within the business and the like. The intelligence and the reconciliation has been removed from the workers to the manager or owner of the business. The store clerks are only required to enter a few keystrokes to utilize the reporting service 144 for generating a particular report.

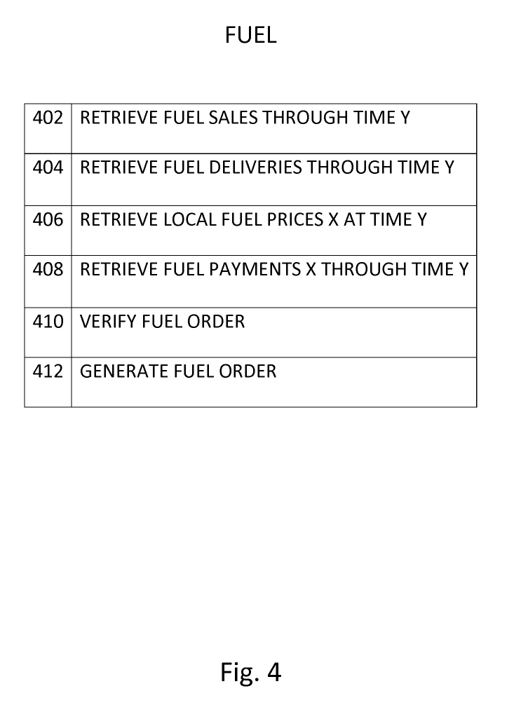

FIG. 4 is a diagram 400 illustrating functionality for processing fuel records and information. The business management service 140 provides routines to retrieve fuel sales though a specified time 402, retrieve fuel deliveries through a specified time 404, retrieve local fuel prices at a specified time 406, retrieve fuel payments through a specified time 408, verify a fuel order has been placed 410, and generate a fuel order 412.

In one example, when a jobber appears with a fuel delivery the user may immediately verify that a fuel order has been placed, and then accept the delivery if verified, or reject the delivery if there has been no order. Additionally, the business management service 140 retrieves the local fuel prices immediately so that an invoice can be generated for a correct amount. The business management service 140 can verify all batches, and that the correct amounts are credited at the time the invoice is created. Additionally, processing fees can also be verified. In this way, the store owner or manager is not vulnerable to price fluctuations that could end up costing significantly more at settlement.

In one embodiment, the fuel order and delivery option is selected and the order quantity is entered. After selecting the save option, the received option is selected for entering the delivery quantities. The update option provides for updating the fuel delivery quantity.

Further, when a fuel invoice is entered into the system 100, the business management service 140 verifies the quantity and the rack price. The owner or manager is then notified, for example, by email that confirms the transaction and as much of the related information as necessary. Notifications and the included information are selectable within the business management service 140.

Utilizing a portion of the provided routines provides the capability for determining a snapshot of sales, and/orders at present, at some point past, or during a window of time. Such capability allows a user or store manager to maximize profits according to particular patterns gathered from the fuel records and when certain fuels should be re-ordered, from whom, and whether any other noticeable patterns are discernible.

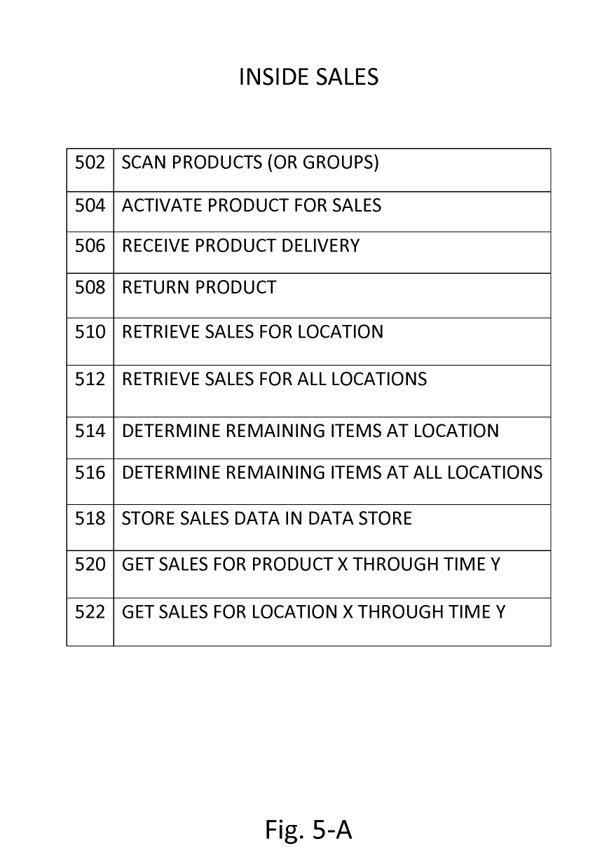

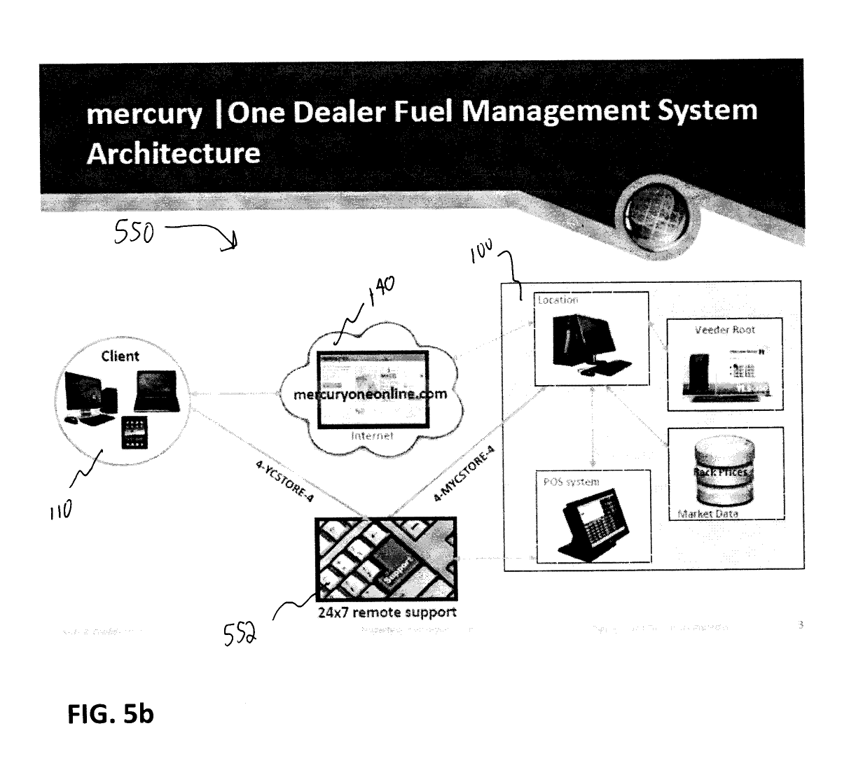

FIG. 5 is a diagram 500 illustrating functionality for processing inside sales records and information for a store. Functionality is similar to the routines for auditing the lottery sales but are applied to products and locations within a store. For example the bin terminology applied to lottery packs is equally applicable to a shelf location having capability for a certain amount of a particular item.

The business management service 140 provides routines to scan products or groups of products into the records 402, activate a product or group of products for sales 404 (putting them on the shelf and scanning), receive delivery of a product or group of products into inventory 406, return products (or group) 408, retrieve the current sales total for a location 410, retrieve the current sales total for all locations (total product sales) 412, determine the remaining items for a location 414, and determine the remaining items at all locations 416. A routine for storing data 418 provides capability for permanently storing any or all data into the inside sales records 164 in the data store 160. A routine to get sales for product X through time Y 420, provides for the capability of determining sales of a product during a range or period of time. A similar routine to get sale for a location X through time Y 422, provides for determining how sales are affected by the location of the product within the store. In this way, the business management service 140 provides capability for retrieving the above information at a given time past or present via accessing the inside sales records 164 in the data store 160. It should be noted that other routines may be provided and that additional routines may be created via utilizing these exemplary routines.

Utilizing a portion of the provided routines provides the capability for determining a snapshot of product sales at present, at some point past, at a particular location or even at a group of locations, or during a window of time. For example, a user could ascertain whether certain products are less likely to sell, or whether certain products are likely to sell in any location while others do not. Such capability allows a user or store manager to maximize profits according to particular results gathered from the inside sales records.

Additionally, the above routines provide the capability for tracking product sales according to age. For example, an owner may determine that certain products and/or locations have been aging for too long a window of time. This provides an indication that these particular products are either not selling or are not selling in the current location.

To track AND reconcile shift closings, the business management service 140 verifies lottery scratch information, payouts, and online data and reconciles POS cash to cash drops after every shift. The information is then relayed via a daily e-mail.

The business management service 140 audits the lottery twice a week. For example, on Tuesday, it validates EFT sweeps and notifies the client via email and each Sunday, the system conducts a lottery scratch audit and notifies the client with an email confirmation.

The platform home screen user interface (dashboard) shows a shift date in the upper left-hand corner (ex. “Shift Date Jun. 23, 2012”), the current shift in progress (ex. “Shift 1 in progress”) in the upper center of the screen, and the store name in the upper right-hand corner (ex. “Om Valero).

The upper left-hand box labeled “Lottery Shift Activities” contains one large selection button reading “Lottery Activation,” and four smaller selection buttons reading “Lottery Delivery & Inventory,” “Activity Log,” “Full Pack Sales” and “Lottery Returns,” in clockwise order from top left to bottom left selection button.

The box on the upper right-hand includes the term “Other Shift Activites” and contains five equally sized selection buttons displaying (from left to right): “Fuel Order and Delivery,” “Customer Credits and Payments,” “Register Expenses,” “Shift Start Reading,” and “Log In/Out.”

The majority of the bottom of the page is a box labeled “Local Fuel Prices,” except for a button in the right corner that reads “Double-Click for Shift End.” Under the “Local Fuel Prices” box, competing fuel sales locations are listed by categories: brand, location, regular, mid-grade, premium and diesel prices (in that order.) There is a small blue refresh button in the corner of the box.

The dashboard provides a view of sales, income, expenses, fuel inventory for the rest of the month, and other notifications and alerts that provide metrics in the industry. For example, shift closings can be reviewed quickly and efficiently, all data from inside sales can be reviewed as meticulously as desired. And the business management service 140 can be accessed from any location safely and securely.

Specific details are provided for the complete records. A reconciliation of the lottery between the system 100 and the lottery records, and the POS 120. Paperwork that typically takes 3 hours is reduced to minutes.

Additionally, a snapshot is provided for any type analysis such as year-to-date, month-to-date, etc.

The business management service 140 provides information for a fuel order by providing totals based on the shifts of the workers. Information such as total sales, profits, the background as to why or why not and how much fuel remains in the tanks.

A report can be provided for an entire cash flow statement and an income statement, profit, net operating income, expenses, and the like.

For example, a store receives fuel on October 13 for 1,200 gallons. The breakdown of 1200 gallons is price per gallon from market data is provided the business management service 140 including taxes, rate, surcharges, etc. In a moment the business management service 140 determines whether the numbers are consistent.

For another example the lottery part the dashboard it shows you exactly how many packs you have. It shows the status of the packs. And the bin mappings can be reviewed also. The counts can be determined realtime and discrepancies can be resolved even with differing settlement schedules.

The “Quick Menu,” is a group of selectors that provide the logged-in user with the ability to conveniently access six basic business management service 140 capabilities from any part of the program. The first selector is labeled “Home” and allows the user to quickly return to the system's root menu or “Home Screen” illustrated in FIG. 3b. A second selector, “About MercuryOne,” allows the user to access information about the system 100 and manufacturer. A third selector, “Remote Support,” supplies the user with contact information for system technical experts that provide 24/7 support, in the event that instruction or troubleshooting is needed. A fourth selector, “MercuryOne Logout,” exits the program. A fifth selector, “Restart,” closes the program then returns the system to the initial login functionality. A sixth selector, “Shut Down,” closes the program.

A store employee utilizes a check-in process to login to the system. Data is organized by distinguishing which transactions or business management service 140 functions occur under distinct users. The text displays a message asking: “Are you opening the store today (or) Are you starting a new shift? Answering yes takes the employee back to the shift start process. Answering no provides a prompt to login using a sign-in ID and password.

A check-out process displays text prompting to logout into the system by entering a personal password.

Log in and log out is very simple. The business management service 140 providing business management service 140 access records as to who is working the respective shift. Any issues can be easily resolved.

Following are details for starting a shift. The employee is prompted with a message to start a shift requiring “(1) You must be logged in to mercury one. If you are not logged in, sign-in using store-id and store password, (2) Select the (a) shift (Shift 1, Shift 2, Shift 3 you want to start,” and the “(b) Shift date from the calendar,” then SELECT DATE and SELECT SHIFT. A prompt is provided to login to the system using a personal sign-in ID and password and then a prompt to review and validate the previous shift start readings. The options are to (10 SHIFT START READING from other shift activities or (2) change the counts if needed. A store manager or owner should be notified immediately in such an instance.

The business management service 140 provides for simplicity of use. Currently store clerks write down many of the records leading to lost time and errors. The paperwork is reduced to a very simple dimension and requires less time for the sales aspect. The convenience store business includes three primary functions including fuel sales, lottery sales, and inside sales. Some stores may not have all three aspects but will usually have two of the three.

At shift end, the business management process 140 also provides for customer credits and payments, register expenses (refunds, etc.) and then remaining shift end activities.

The customer credits and payments option is selected followed by the customer name. Selecting credits provides for entering the fuel type quantity or sales. Selecting save completes the credit. Selecting payments provides for entering the total amount and payment type. Selecting save completes the payment. Credits and payments are changed by selecting Edit in the shift log portion of the display.

Register expenses are provided by selecting the register expenses option. An expense is entered by selecting vendor, then payment type, and then entering the amount. A delivery for phone cards is entered by selecting the phone card option and entering the phone card delivery quantity. For a check the number is entered by selecting payment type. An expense is changed by selecting the edit option in the shift log box.

Shifting end activities are provided by loading the POS 120 data. Selecting the load POA option provides for loading data from the POS 120. If unsuccessful an error message occurs and the data is entered manually. For Gilbarco, fuel sales and grocery sales are loaded. For Ruby Sapphire, fuel sales, grocery sales and jobber batches and credit card info is loaded.

The improved records provide for instant availability to determine whether to provide additional credit to some and to withhold from those who are past due. The information is immediately available to the clerk with only a few keystrokes.

During shift end processing, a re-boot confirmation screen precedes the beginning of fuel sales. For fuel sales the fuel sales option is selected, and the quantity and amount is entered. Save completes the process.

During shift end processing, the grocery sales option is selected and the grocery sales net amount and value tax are collected, followed by selecting the save option.

During shift end processing, the Veeder-Root reading option is selected and the fuel reading end counts are entered. Saving completes the process.

During shift end processing, the lottery sales option is selected and all the lotteries are scanned. Each empty bin is then selected and closed.

During shift end processing, a lottery report can be generated by the reporting service 144 and the lottery values are entered into the report

During shift end processing for phone card and cigarette reading. The cigarettes end count is entered and saved. The scratch sale count is entered and saved. The online option is selected. The online sale count is entered and saved.

Also during shift end processing, the network transaction option is selected. The credit and debit count and values are entered.

Once preliminary shift end processing has been completed, the shift end option is selected and the batch numbers and amounts are entered. More batches are added by selection the add option and then saving. Cash drop is then entered and the close shift option is selected.

Shift data is also tracked between multiple operators. The business management service 140 provides a concise summary of the jobber credits accumulated during one operator's shift and the total cash drop for the business during a clearly-defined period.

Relevant data is gathered from the operator's shift and organized, including a breakdown of total business processes conducted: specifically lottery transactions, jobber transactions, and fuel delivery and sales.

The automated fuel data collection process is performed by the business management service 140 at the time the information becomes available. By cross-checking sales between Veeder Root readings and the POS 120, automating collection of fuel sales, volume readings and price, the business management service 140 eliminates the need for a store operator to manually change and update information, reducing occurrence of error, and facilitating efficiency in store operations.

A Dealer Fuel Management System (DFMS) provides the owner with additional mobility by allowing off-site monitoring of location equipment. The DFMS provides for automated collection of fuel sales, volume readings, and price from dealer location. The DFMS also ensures that no manual changes or updates occur at the dealer location. POS 120 sales are cross-checked to vendor root readings. Limit sales, expenses, batches and settlements information is provided to the marketer. The DFMS also provides for monitor equipment at the location.

FIG. 5-B is a flowchart showing the way DFMS 550 facilitates interaction various components of an embodiment of the system 100, including the client computing device 110, the business management service 140, the system 100, 24/7 support 552, market data 142, Veeder-Root data and POS 120.

Minimal hardware and network access tools are necessary to collect and coordinate the necessary information to maximize utility of the DFMS.

A small PC at the dealer location to collect data, referred to as the Jobber Fuel Agent (JFA), Veeder Root card to capture volume and delivery details, Internet access at the dealer location, a router to connect POS to the JFA, a router to connect the JFA to the internet, and access to all locations for the marketer, or Jobber Fuel Manager (JFM).

The business management service 140 uses network capability to automatically collect real-time data from internet sources accessed by the system 100 from extensive online resources and display the information to both the client (owner/manager) and the store operator as soon as that information becomes available.

The business management service 140 simplifies the monitoring and facilitating the processing of checks and displaying that information to the client through algorithms.

The business management service 140 simplifies the interface with the operator, facilitating improved accuracy and efficiency of transactions while allowing automated tracking of all elements of the convenience store business, including fuel, lottery, sales and inventory transactions.

The initial lottery bin setup is utilized to tell the system the selection, price, games, and pertinent details to enable the system to automatically verify and reconcile the store POS 120 with market data, including lottery sweeps, EFT and data from other locations.

When a clerk takes a delivery it is immediately scanned and entered into the system. As such, an up to date inventory is provided for ease of tracking.

Stores include a concept called ‘bins.’ The system includes a created a bin structure, depending on how many number of bins available, it shows the clerk a real view of what is the bins. Or what games are located in particular bins. This allows for analysis as to which bins sell more based on product or location or other factors.

The business management service 140 also provides for analysis as to aging products, that sit on the shelves too long. If things are not selling, they can be removed or not reordered.

The business management service 140 overview is available to the store operator or client at any time, reflecting current sales totals or the performance of any specific bin, over any range of time. Monitoring the length of time packs remain on the shelves facilitates improved inventory selection and management.

The business management service 140 also provides up-to-date availability of money order information in detailed and comprehensive format to the client at any point.

An array of market data fields is used as a template for the business management service 140 and for the collection of data and subsequent creation of reports then made available to the client computing device 110 via the reporting service 144.

An invoice is automatically created base on the current day's wholesale price of fuel or products and based on the current market environment. For example, the exact cost of fuel from a particular provider is for a particular date is available.

The owner is receiving a confirmation of the delivery amount, and an invoice is created instantly. The invoice can be immediately compared with the one received from a wholesale or vender to determine whether they match. The activities that previously required 30-40 minutes is performed in minutes with the business process management application.

The business management service 140 shift report provides the operator's activities which are automatically monitored, summarized, generated and sent to the client via email notification with a snapshot of all shift info summarily organized and then broken down into the convenience store owner's three primary business categories: Inside Sales, Fuel Sales, Lottery Sales and Network Sales.

The business management service 140 also analyzes and organizes market data for distribution to clients and the system 100 in-store via cloud computing.

The business management service 140 provides for review and adjustment of current store sales, and also the addition of new sales.

The business management service 140 is accessible to clients via cloud computing from any location with internet access. The business management service 140 has presence, security and login capabilities, providing client access through the internet from any location worldwide.

The business management service 140 also provides functionality for handheld devices. The availability of handheld devices provides another method for using and updating the catalog inventory in the store.

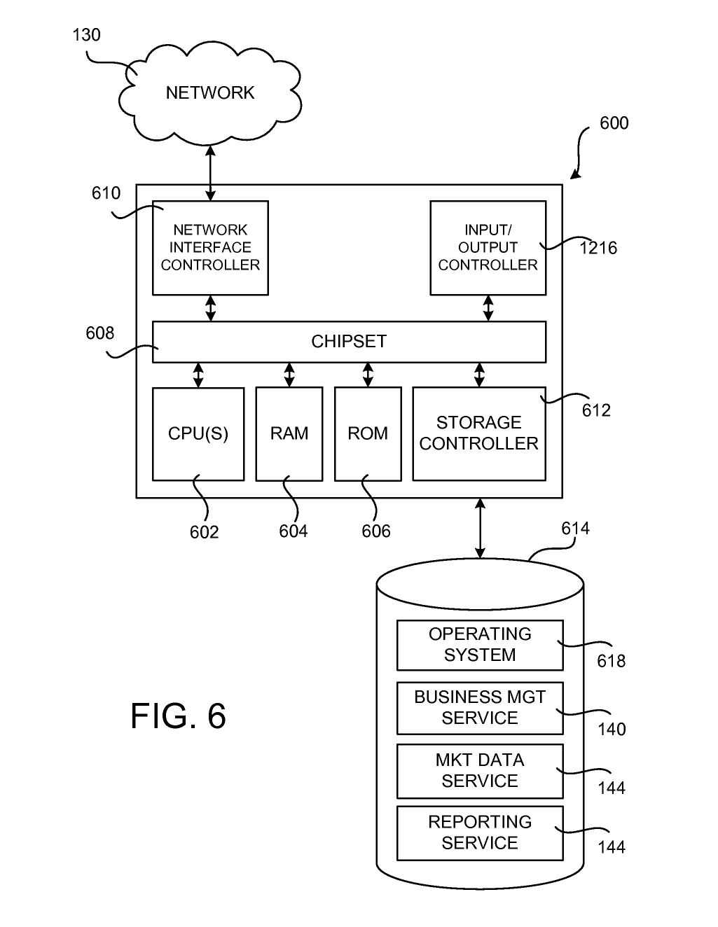

FIG. 6 shows an example computer architecture for a computer 600 capable of executing the software components described herein. The computer architecture shown in FIG. 6 illustrates a conventional server computer, workstation, desktop computer, laptop, network appliance, personal digital assistant (“PDA”), electronic book reader, digital cellular phone, or other computing device, and may be utilized to execute any aspects of the software components presented herein. For example, and without limitation, the computer architecture shown in FIG. 6 might be utilized to implement computer systems that execute software components for implementing the functionality provided by the client computing devices 110, business management service 140, market data service 142, and reporting service 144.

The computer 600 includes a baseboard, or “motherboard,” which is a printed circuit board to which a multitude of components or devices may be connected by way of a system bus or other electrical communication paths. In one illustrative embodiment, one or more central processing units (“CPUs”) 602 operate in conjunction with a chipset 608. The CPUs 602 are standard programmable processors that perform arithmetic and logical operations necessary for the operation of the computer 600.

The CPUs 602 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 608 provides an interface between the CPUs 602 and other components and devices on the baseboard. For instance, the chipset 608 may provide an interface to a random access memory (“RAM”) 604, used as the main memory in the computer 600. The chipset 608 may further provide an interface to a computer-readable storage medium such as a read-only memory (“ROM”) 606 or non-volatile RAM (“NVRAM”) for storing basic routines that help to startup the computer 600 and to transfer information between the various components and devices. The ROM 606 or NVRAM may also store other software components necessary for the operation of the computer 600 in accordance with the embodiments described herein.

According to various embodiments, the computer 600 may operate in a networked environment using logical connections to remote computing devices and computer systems through the network 620, such as a local-area network (“LAN”), a wide-area network (“WAN”), the Internet, or any other networking topology known in the art that connects the computer 1200 to remote computers. The chipset 608 includes functionality for providing network connectivity through a network interface controller (“NIC”) 610, such as a gigabit Ethernet adapter. The NIC 610 is capable of connecting the computer 600 to other computing devices over the network 620. It should be appreciated that any number of NICs 610 may be present in the computer 1200, connecting the computer 600 to various types of networks and remote computer systems.

The computer 600 may be connected to a mass storage device 614 that provides non-volatile storage for the computer 600. The mass storage device 614 may store system programs, application programs, other program modules, and data, which are described in greater detail herein. The mass storage device 614 may be connected to the computer 600 through a storage controller 612 connected to the chipset 608. The mass storage device 614 may consist of one or more physical storage units. The storage controller 612 may interface with the physical storage units through a serial attached SCSI (“SAS”) interface, a serial advanced technology attachment (“SATA”) interface, a fiber channel (“FC”) interface, or other standard interface for physically connecting and transferring data between computers and physical storage devices.

The computer 600 may store data on the mass storage device 614 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 614 is characterized as primary or secondary storage, and the like. For example, the computer 600 may store information to the mass storage device 614 by issuing instructions through the storage controller 612 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 may further read information from the mass storage device 614 by detecting the physical states or characteristics of one or more particular locations within the physical storage units.

In addition to the mass storage device 614 described above, the computer 600 may have access to other computer-readable storage media to store and retrieve information, such as program modules, data structures, or other data. It should be appreciated by those skilled in the art that computer-readable storage media can be any available non-transitory media that may be accessed by the computer 600. By way of example, and not limitation, computer-readable storage media may include volatile and non-volatile, removable and non-removable media implemented in any method or technology. Computer-readable storage media includes RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 614 may store an operating system 618 utilized to control the operation of the computer 600. According to one embodiment, the operating system comprises the LINUX operating system. According to another embodiment, the operating system comprises the WINDOWS® SERVER operating system from MICROSOFT Corporation of Redmond, Wash. According to further embodiments, the operating system may comprise the UNIX or SOLARIS operating systems. It should be appreciated that other operating systems may also be utilized. The mass storage device 614 may store other system or application programs and data utilized by the computer 600, such as the business management service 140, the market data service 142, and/or the reporting service 151442, of which was described above in regard to FIGS. 1-5B.

In one embodiment, the mass storage device 614 or other computer-readable storage media may be encoded with computer-executable instructions that, when loaded into the computer 600, may transform the computer from a general-purpose computing system into a special-purpose computer capable of implementing the embodiments described herein. These computer-executable instructions transform the computer 600 by specifying how the CPUs 602 transition between states, as described above. According to one embodiment, the computer 600 may have access to computer-readable storage media storing computer-executable instructions that, when executed by the computer, perform the routines 200, 300, 400, 500, 600, 700, 800, and 900 described above with regard to FIGS. 2 through 9, respectively.

The computer 600 might also include an input/output controller 616 for receiving and processing input from a number of input devices, such as a keyboard, a mouse, a touchpad, a touch screen, an electronic stylus, or other type of input device. Similarly, the input/output controller 616 may provide output to a display, such as a computer monitor, a flat-panel display, a digital projector, a printer, a plotter, or other type of output device. It will be appreciated that the computer 600 may not include all of the components shown in FIG. 6, may include other components that are not explicitly shown in FIG. 6, or may utilize an architecture completely different than that shown in FIG. 6.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example embodiments and applications illustrated and described, and without departing from the true spirit and scope of the present invention, which is set forth in the following claims.

What is claimed is:

1. A computer-implemented method for managing business processes within a business management system, the method comprising:
auditing lottery activity via synchronizing a point a point-of-sale terminal with a computing device,
utilizing lottery data retrieved from the point-of-sale terminal to determine sales corresponding to at least one lottery game;
analyzing retrieved sales data to determine sales corresponding to the at least one lottery game over a period of time; and
providing results from analysis to a user for determination whether to continue providing the at least one lottery game.

2. A computer-implemented method for managing business processes within a business management system, the method comprising:
auditing fuel sale activity via synchronizing a point a point-of-sale terminal with a computing device,
utilizing fuel sale data retrieved from the point-of-sale terminal to determine sales for fuel received from a specified vendor over a period of time; and
providing results from analysis to a user for determination whether to continue purchasing from said vendor.
